(19) United States
(12) Patent Application Publication
(10) Pub. No.: US 2025/0038232 A1
(43) Pub. Date: Jan. 30, 2025

(54) METHOD FOR OPERATING A FUEL CELL SYSTEM, AND A CONTROL DEVICE

(71) Applicant: Robert Bosch GmbH, Stuttgart (DE)

(72) Inventors: Andreas Beiter, Rangendingen (DE); Christoph Weisser, Gerlingen (DE); Timo Bosch, Renningen (DE); Tobias Falkenau, Esslingen (DE)

(21) Appl. No.: 18/717,028

(22) PCT Filed: Dec. 5, 2022
(86) PCT No.: PCT/EP2022/084336

§ 371 Date: Jun. 6, 2024

(30) Foreign Application Priority Data
Dec. 14, 2021 (DE) 10 2021 214 309.1

(51) Int. Cl. H01M 8/04119; H01M 8/0438; H01M 8/04828

(52) U.S. Cl. CPC H01M 8/04164; H01M 8/04388; H01M 8/04828

(57) ABSTRACT

The invention relates to a method for operating a fuel cell system (1), wherein, via a fuel line (20), hydrogen from a tank (21) and recirculated hydrogen from a recirculation circuit (50) as the anode gas are supplied to at least one fuel cell (101), and water (6) contained in the anode gas is removed by means of a water separator (2) integrated into the recirculation circuit (50), is collected in a container (3) and is removed from the system by intermittently opening a drain valve (41).

The following steps are carried out to detect whether the container (3) is full:
opening the drain valve (41) located on the container (3),
detecting an erratic change in pressure in the fuel line (20) upstream of a hydrogen metering valve (51),
identifying that the container (3) is empty.

The invention further relates to a control device (27) for carrying out the method or individual method steps.

### BACKGROUND

The invention relates to a method for operating a fuel cell system. Furthermore, the invention relates to a control device configured so as to carry out steps of the method.

A PEM fuel cell comprises a polymer electrolyte membrane arranged between an anode and a cathode. Using the PEM fuel cell, hydrogen fed to the anode and oxygen fed in the form of air to the cathode can be converted into electrical energy, heat, and water. In practical application, a plurality of fuel cells are gathered together to form a fuel cell stack, also known as a “stack,” in order to increase the generated electric voltage.

Water produced during the electrochemical reaction in the fuel cell must be removed from the anode gas. For this purpose, a water separator with a container is integrated into the recirculation circuit, in which the separated water is collected. Depending on the fill level in the container, a drain valve is opened and the container is emptied. In order to detect when the container needs to be emptied, the fill level in the container can be monitored by means of a fill level sensor. In mobile applications, however, this level sensor is subject to fluctuations and/or vibrations that can affect the measurement result, such that the use of a fill level sensor is problematic. Moreover, the fill level sensor increases costs.

The present invention therefore addresses the problem of providing a method for operating a fuel cell system that allows for a reliable and at the same time inexpensive monitoring of the fill level in a container for collecting separated water without a fill level sensor.

In order to solve this problem, the method according to the disclosure is proposed. Advantageous embodiments of the invention can be gathered from the dependent claims. In addition, a control device for carrying out the method or individual method steps is specified.

### SUMMARY

In the proposed method for operating a fuel cell system, hydrogen is supplied from a tank and recirculated hydrogen is supplied from a recirculation circuit to a fuel cell as anode gas via a fuel line and water contained in the anode gas is separated by means of a water separator integrated in the recirculation circuit, collected in a container and removed from the system by temporarily opening a drain valve.

The following steps are carried out:
opening the drain valve located on the container;
detecting an erratic change in pressure in the fuel line upstream of a hydrogen metering valve;
identifying that the container is empty.

When the container is full or the water level lies above the connection site of the drain valve, water instead of gas initially exits upon opening of the drain valve. The set pressure in the recirculation circuit hardly changes, so that the amount of hydrogen supplied via the hydrogen metering valve for pressure equalization remains essentially the same. Only when gas is discharged via the drain valve instead of water does the opened hydrogen metering valve need to be opened further in order to maintain the set pressure. This happens abruptly and can therefore be taken as a clear indication that gas is now escaping and the container is empty.

As long as only water and no gas is discharged from the container via the drain valve, hardly any hydrogen needs to be added-despite the water column becoming smaller. This is because discharging water only has a minor effect on the set pressure in the recirculation circuit.

It is advantageous if the signal from a pressure sensor in the fuel line is evaluated to detect the sudden change in pressure in the fuel line, as this is a simple and accurate way of detecting a change in pressure.

There is a further advantage if the actuator current for controlling the hydrogen dosing valve is evaluated to detect the sudden change in pressure in the fuel line, as no additional costs are incurred by the pressure sensor.

If the time (t) at which the container is empty is stored at least temporarily in a control unit, this is advantageous because this information can be used to control other functions in the fuel cell system.

There is a particular advantage if the drain valve is closed immediately after the sudden change in pressure is identified, as no hydrogen can escape into the environment.

Furthermore, it is proposed that signals that are used as the basis for the evaluation of the actuator current are previously subjected to a filtering and/or averaged over time. In this way, the accuracy of the evaluation can be increased.

Preferably, a debouncing time of the drain valve is taken into account when evaluating the pressure. This means that a certain time offset between the activation and opening of the drain valve is included in the evaluation. In this way, the accuracy of the evaluation can be further increased.

Furthermore, a load change that occurs when the purge valve is open is taken into account when evaluating the pressure. A load change that can occur when the purge valve is open is taken into account when evaluating the pressure.

In addition, a control device that is configured so as to carry out steps of the method according to the invention is proposed. In particular, the actuator current required to actuate the hydrogen metering valve can be acquired and evaluated using the control valve. If the evaluation results in a delayed increase in the actuator current after the drain valve is opened, this indicates an empty container. In this case, the control device can be used in order to actuate and open the drain valve so as to empty the container. To evaluate the actuator current, a corresponding algorithm is preferably stored in the control unit.

### BRIEF DESCRIPTION OF THE DRAWINGS

The invention and its advantages are explained in more detail below with reference to the accompanying drawings. Shown are:

FIG. 1 a schematic representation of the topology of a fuel cell system;

FIG. 2 a schematic representation of a water separator integrated into a recirculation circuit of a fuel cell system, and

FIG. 3 a diagram for graphical representation of the pressure curve in the fuel line as a function of the fill level in the water separator container.

### DETAILED DESCRIPTION

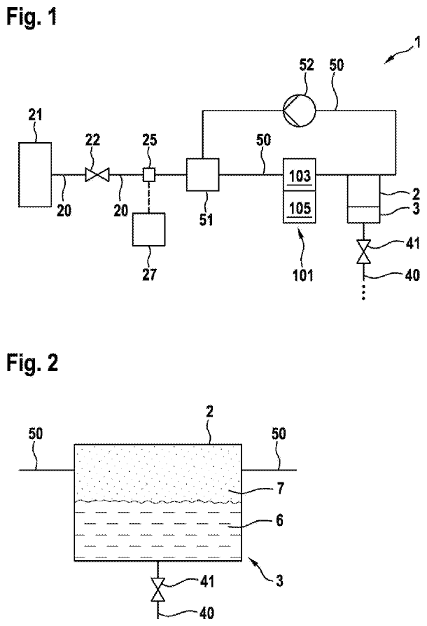

FIG. 1 shows a schematic topology of a fuel cell system 1 according to a first exemplary embodiment of the invention, having at least one fuel cell stack 101.

The fuel cell stack 101 has a cathode side 105 and an anode side 103. The anode side 103 is supplied with hydrogen via a fuel line 20. A high-pressure tank 21 and a pressure control valve 22 are located at the inlet of the fuel line 20. Additional components can be arranged in the fuel line 20 so as to supply fuel to an anode side 103 of the fuel cell stack 101 as needed.

Excess fuel, as well as certain amounts of water and nitrogen that diffuse through the cell membranes onto the anode side 103, are returned to a recirculation circuit 50 and mixed with the metered fuel from the fuel line 20.

Various components, such as a fan 52, can be installed to drive the flow in the recirculation circuit 50. A hydrogen metering valve 51 is arranged at the transition between fuel line 20 and recirculation circuit 50.

The hydrogen metering valve 51 ensures the supply of fresh hydrogen to the recirculation circuit 50. The hydrogen metering valve 51 can be designed as a proportional valve. The control strategy in the fuel cell system envisages using the hydrogen metering valve 51 to regulate the gas pressure within the recirculation circuit 50 to a defined setpoint pressure depending on the system operating point. Reasons for the replenishment of fresh hydrogen can be the consumption of hydrogen by the electrochemical conversion within the fuel cell stack 101 or other losses of gas molecules from the recirculation circuit 50, such as by opening the drain valve 41.

A water separator 2 is integrated in the recirculation circuit 50 to separate water from the anode gas in the recirculation circuit 50. The water separator has a container 3 for collecting the separated water. In order to empty this container 3, the container is connected to a drain line 40 via a drain valve 41. The drain line 40 typically leads the excess water into an exhaust line, which is connected to the environment.

A pressure sensor 25 is arranged in the fuel line 20. The pressure sensor 25 is arranged upstream of the hydrogen metering valve 51 and measures the pressure between the pressure regulator 22 and the hydrogen metering valve 51 in the fuel line 20.

FIG. 2 shows an example of a water separator 2 integrated into a recirculation circuit 50. The water separator 2 comprises a container 3 for collecting water 6, which is separated from the recirculation circuit 50 by means of the water separator 2. The drain valve 4 is located at the bottom to empty the container 3. This is opened depending on the fill level of the container 3.

Water 6 and possibly gas 7, which escapes from the container 3 when the drain valve 41 is opened, is replaced by fresh hydrogen. This is metered into the recirculation circuit 50 with the aid of the hydrogen metering valve 51. The hydrogen metering valve 51 or an actuator (not shown) of the hydrogen metering valve 51 is controlled accordingly via a control unit 27.

The method according to the invention provides for the pressure in the fuel line 20 to be observed after the drain valve 41 is opened. If a sudden change in the pressure in the fuel line 20 upstream of a hydrogen metering valve 51 is detected, an empty container 3 is identified.

To detect the pressure in the fuel line 20, the signal from the pressure sensor 25 in the fuel line 20 can be evaluated according to a first exemplary embodiment.

According to a second embodiment, the actuator current for actuating the hydrogen metering valve 51 can be evaluated to detect the sudden change in pressure in the fuel line 20. If the actuator current rises above a threshold value, a large amount of fuel is fed through the hydrogen metering valve 51 into the recirculation circuit 50. The pressure in the fuel line 20 between pressure control valve 22 and hydrogen metering valve 51 consequently drops.

A control unit 27 of the fuel cell system 1 can be used to evaluate the actuator current, with the aid of which the hydrogen metering valve 51 is controlled.

The time (t) at which the container 3 is empty can be stored at least temporarily in the control unit 27 and corresponding information is sent to other functions in the fuel cell system 1.

In one embodiment, the information or the time (t) at which the container is empty can be used as the start time for a purge process initiated directly downstream via the drain valve 41.

To prevent hydrogen from escaping into the environment via the drain line 40 after draining, the drain valve 41 is closed after the sudden change in pressure is identified.

Preferably, no change in the operating conditions or the load should occur during the method according to the invention; if this does occur, any load change that occurs is taken into account when evaluating the actuator current or pressure.

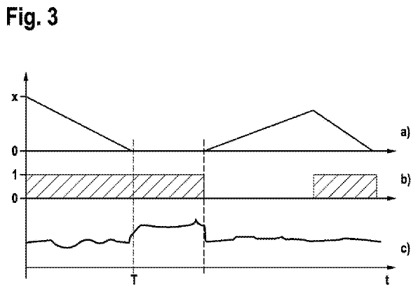

FIG. 3 shows the background to the method according to the invention. The top diagram a) describes the fill level of container 3. In the diagram a) shown, container 3 is initially filled with water up to level x. When the drain valve 41 is opened, the level drops to 0 at time T. After some time, the container 3 is filled again up to a maximum and then the fill level drops.

The middle diagram b) describes the opening state of the drain valve 41. In state 1, the drain valve 41 is open; in state 0, the three-way valve 41 is closed.

The bottom diagram c) describes the pressure curve at the pressure sensor 25 in the fuel line 20. At time T, the pressure changes due to the fact that gas can escape from the container 3 from this time T onwards.

If the fuel cell system 1 is in stationary operation and the container 3 is emptied by opening the drain valve 41 with water flowing out, the hydrogen metering valve 51 only has to counter-adjust slightly in order to bring the volume in the recirculation circuit 50, which has been increased by the volume of water, to the set pressure.

However, if all the water is drained after some time and the drain valve 41 is not closed, gas escapes from the recirculation circuit 50. As a result, the hydrogen metering valve 51 must be actuated with a higher current in order to maintain the set pressure, which means that more hydrogen is pumped. Due to the greater mass flow in the fuel line 20, there is a greater pressure loss. This pressure loss in the fuel line 20 can be measured with the pressure sensor 35 upstream of the hydrogen metering valve 51.

The changed pressure can be detected precisely and with a high measuring frequency in a control unit 51 either with the aid of the pressure sensor 25 or by increasing the actuator current on the hydrogen metering valve 51, whereby the proposed algorithm recognizes the empty state and its time.

1. A method for operating a fuel cell system, wherein, via a fuel line (20), hydrogen from a tank (21) and recirculated hydrogen from a recirculation circuit (50) as the anode gas are supplied to at least one fuel cell (101), and water (6) contained in the anode gas is removed by means of a water separator (2) integrated into the recirculation circuit (50), is collected in a container (3), and is removed from the system by intermittently opening a drain valve (41),
wherein method comprises:
opening, via control unit (27), the drain valve (41) located on the container (3),
detecting, via a pressure sensor (25), change in pressure in the fuel line (20) upstream of a hydrogen metering valve (51), and
identifying, via the control unit (27) that the container (3) is empty.

2. The method according to claim 1,
wherein the signal of the pressure sensor (25) in the fuel line (20) is evaluated to detect the change in pressure in the fuel line (20).

3. The method according to claim 1,
wherein the actuator current for actuating the hydrogen metering valve (51) is evaluated to detect the change in pressure in the fuel line (20).

4. The method according to claim 3,
wherein, to evaluate the actuator current, a control unit (27) of the fuel cell system is used, with the aid of which the hydrogen metering valve (51) is actuated.

5. The method according to claim 1,
wherein the time (t) at which the container (2) is empty is stored at least temporarily in a control unit (27) and corresponding information is sent to other functions in the fuel cell system.

6. The method according to claim 1,
wherein the drain valve (41) is closed after the sudden change in pressure has been identified.

7. The method according to claim 2,
wherein a debouncing time of the drain valve (41) is taken into account when evaluating the actuator current or the pressure.

8. The method according to claim 2,
wherein a load change occurring when the drain valve (41) is open is taken into account when evaluating the actuator current or pressure.

9. A control unit configured so as to carry out all steps of the method according to claim 1.
